(19) United States
(12) Patent Application Publication
(10) Pub. No.: US 2006/0248253 A1
(43) Pub. Date: Nov. 2, 2006

(54) Motherboard and bridge module therefor

(75) Inventor: Jing Rung Wang, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/246,065

(22) Filed: Oct. 11, 2005

(30) Foreign Application Priority Data
Apr. 29, 2005 (TW) 094114016

(51) Int. Cl. G06F 13/36

(52) U.S. Cl. 710/306; 710/312

(57) ABSTRACT

A motherboard includes at least one first memory socket, at least one second memory socket and a bridge module. The first memory socket is connected to a first memory, and the second memory socket is connected to a second memory. In addition, the bridge module has a first memory controller, a second memory controller, a core unit and a graphic unit. The first memory controller is connected to the first memory socket, the second memory controller is connected to the second memory socket, the core unit accesses the first memory through the first memory controller, and the graphic unit accesses the second memory through the second memory controller.

### BACKGROUND OF THE INVENTION

1. Field of Invention

The present invention relates to a motherboard and a bridge module, and more particularly to a motherboard for integrating a north bridge module with a graphic interface, and a bridge module.

2. Related Art

FIG. 1 is a schematic view showing a conventional personal computer system. Referring to FIG. 1, the personal computer system 1 includes a casing (not shown), a motherboard 11 and a display 12. The motherboard 11 has a central processing unit (CPU) 111, a main bus 112, a north bridge module 113, a main memory bus 114, a main memory 115, a south bridge module 116, an input/output (I/O) bus 117, an advanced graphical port (AGP) bus 118, and a video graphic acceleration (VGA) card 119. The casing accommodates the motherboard 11 and at least one peripheral apparatus 13, such as hard disk, optical drive, power supply or the like, to construct a well-known computer host. In general, the CPU 111 is connected to the north bridge module 113 through the main bus 112, the north bridge module 113 is connected to the main memory 115 through the main memory bus 114, and the north bridge module 113 is connected to the VGA card 119 through the AGP bus 118.

In the personal computer system 1, the CPU 111 controls the overall operation of the computer system 1, and the north bridge module 113 controls the signal transmission between the high-speed peripheral apparatus (e.g., the VGA card 119 and the main memory 115) and the CPU 111. The south bridge module 116 controls the signal transmission between the low-speed peripheral apparatus 13 (e.g., hard disk and I/O device) and the north bridge module 113 through the I/O bus 117. The VGA card 119 performs graphic operations to generate a video signal for driving the display 12. The main memory 115 is a volatile storage device, the hard disk is a non-volatile storage device, and the I/O device receives a control signal inputted by the user or outputs data. In addition, the VGA card 119 includes a graphic unit 1191, a graphic memory 1192 and a flash memory 1193. The graphic memory 1192 is a dynamic memory, and the flash memory 1193 serves as a basic input/output system (BIOS) of the VGA card 119.

With the progress of the technology, another conventional personal computer system 1′ is with no additionally added VGA card 119. Instead, the graphic unit 1191 and the graphic memory 1192 are integrated into the north bridge module 113 and can be directly installed onto a motherboard 11′ such that the cost can be reduced and the manufacturing process of the motherboard 11′ can be simplified. Typically, the personal computer system 1′ without the additionally added VGA card 119 adopts the chipset, such as a north bridge module or an integrated chip, containing the graphic unit 1191, while the graphic memory 1192 can adopt two architectures, one of which is illustrated in FIG. 2. In this architecture, the graphic unit 1191 is disposed in the north bridge module 113 and gets the main memory 115 as the graphic memory through a memory controller 1131 within the north bridge module 113. Thus, the graphic memory is shared from the main memory in this architecture, which is so called unity memory architecture (UMA). Using the UMA inevitably decreases the overall system efficiency because the bandwidth and the size of the main memory 115 have to be shared with the graphic unit 1191.

Consequently, a local frame buffer (LFB) architecture is developed. In this architecture, as shown in FIG. 3, the graphic unit 1191 is directly connected to an independent memory 14 through a memory interface 1194 to serve as the graphic memory. This architecture can avoid the graphic memory from occupying the main memory 115 and prevent the time for the graphic unit 1191 to access the main memory 115 from being wasted. However, the graphic memory is usually disposed on the motherboard, thereby greatly restricting the extensibility and flexibility of the graphic memory.

Therefore, it is an important subject to provide a motherboard and a bridge module having the enhanced system efficiency and capable of enabling the user to extend the graphic memory.

### SUMMARY OF THE INVENTION

In view of the foregoing, the present invention is to provide a motherboard and a bridge module capable of enabling the user to extend the graphic memory.

To achieve the above, a motherboard according to the present invention includes at least one first memory socket, at least one second memory socket and a bridge module. The first memory socket is connected to a first memory, and the second memory socket is connected to a second memory. In addition, the bridge module has a first memory controller, a second memory controller, a core unit and a graphic unit. The first memory controller is connected to the first memory socket, the second memory controller is connected to the second memory socket, the core unit accesses the first memory through the first memory controller, and the graphic unit accesses the second memory through the second memory controller.

To achieve the above, a bridge module according to the present invention works in conjunction with a first memory socket and a second memory socket and includes a first memory controller, a second memory controller, a core unit and a graphic unit. The first memory controller is connected to the first memory socket, the second memory controller is connected to the second memory socket, the core unit is connected to the first memory controller, and the graphic unit is connected to the second memory controller.

As mentioned above, the motherboard and the bridge module according to the present invention enable the user to replace the second memory installed in the second memory socket according to practical requirement, such that the personal computer system has excellent extensibility. In addition, the core unit and the graphic unit in the motherboard and the bridge module according to the present invention respectively access the first memory and the second memory as a main memory and a graphic memory through the first memory controller and the second memory controller, so the overall efficiency can be enhanced.

### BRIEF DESCRIPTION OF THE DRAWINGS

The present invention will become more fully understood from the detailed description given herein below illustration only, and thus is not limitative of the present invention, and wherein:

FIG. 1 is a schematic view showing a conventional personal computer system;

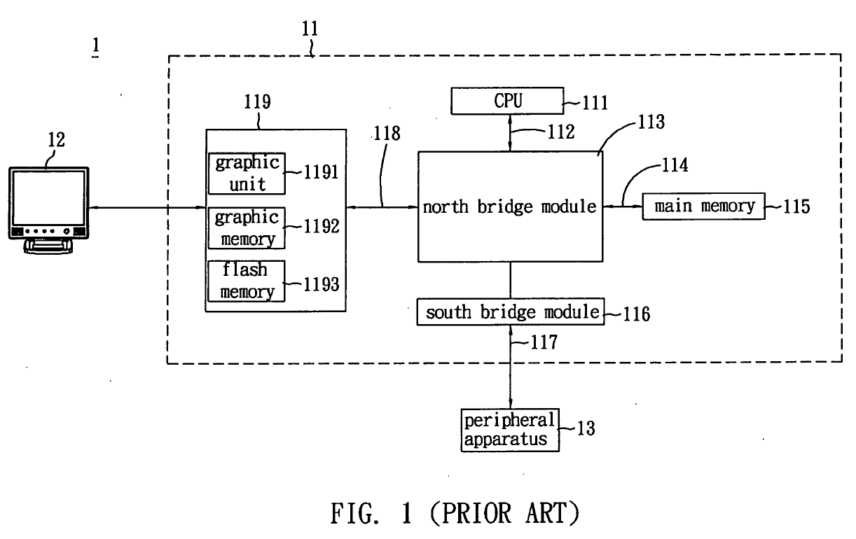

FIG. 2 is a schematic view showing unity memory architecture (UMA) of a conventional personal computer system;

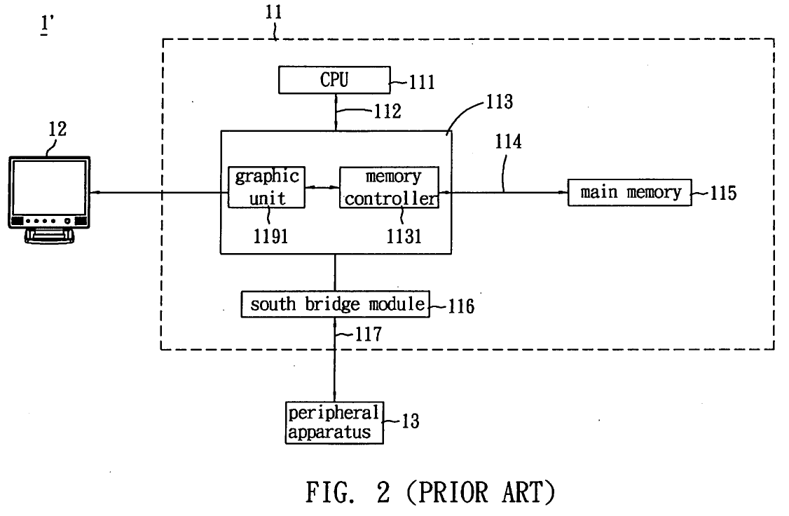

FIG. 3 is a schematic view showing local frame buffer (LFB) architecture of a conventional personal computer system; and

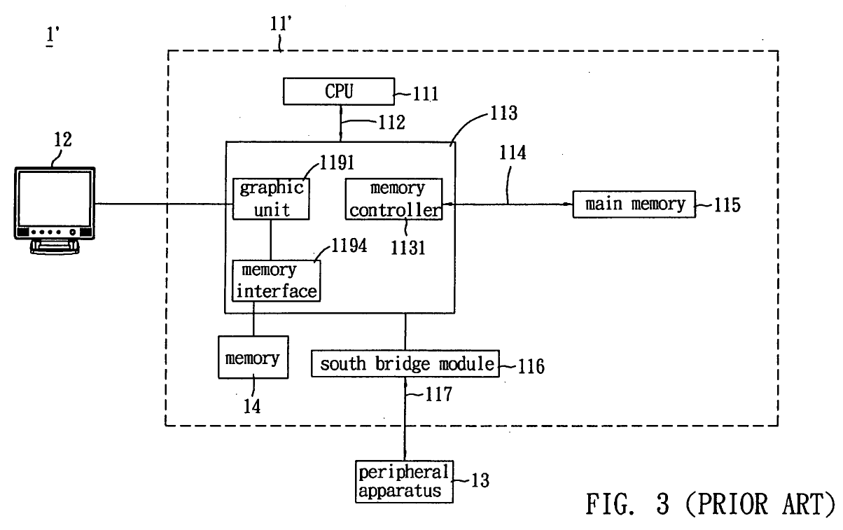

FIG. 4 is a schematic view showing a preferred embodiment of a motherboard according to the present invention.

### DETAILED DESCRIPTION OF THE INVENTION

The present invention will be apparent from the following detailed description, which proceeds with reference to the accompanying drawings, wherein the same references relate to the same elements.

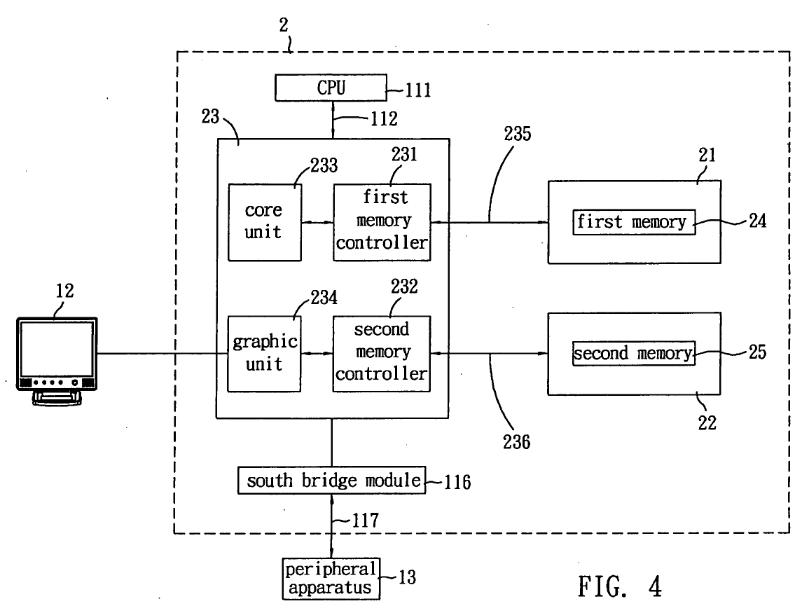

FIG. 4 is a schematic view showing a preferred embodiment of a motherboard 2 according to the present invention. The motherboard 2 is applied to a personal computer system, and the overall operation of the personal computer system has been described hereinabove and the corresponding descriptions are omitted for concise purpose.

The motherboard 2 includes at least one first memory socket 21, at least one second memory socket 22 and a bridge module 23.

In this embodiment, the first memory socket 21 is a dual inline memory module (DIMM) socket. The first memory socket 21 is coupled with a first memory 24, which satisfies the 64-bit access path included in the memory with the dual inline memory specification. Herein, the amount of the first memory socket 21 may be determined by the customer. In usage, the user can install the memory satisfying the specification in the first memory socket 21 to serve as a main memory in the personal computer system. In addition, the first memory socket 21 may also be a single inline memory module socket, and the first memory 24 satisfies the 32-bit access path included in the memory with the single inline memory specification.

The second memory socket 22 is a dual inline memory module socket. The second memory socket 22 is coupled with a second memory 25, which satisfies the 64-bit access path included in the memory with the dual inline memory specification. Herein, the amount of the second memory socket 22 may be determined by the customer. In usage, the user can install the memory satisfying the specification in the second memory socket 22 to serve as a graphic memory in the personal computer system. In addition, the second memory socket 22 may also be a single inline memory module socket, and the second memory 25 satisfies the 32-bit access path included in the memory with the single inline memory specification.

The bridge module 23 may be a north bridge module for controlling the signal transmission between the bridge module 23 and a CPU 111, and a south bridge module 116 controls the signal transmission of at least one low-speed peripheral apparatus 13 through a I/O bus 117. Of course, the bridge module 23 may also be an integrated chip having the south and the north bridge modules, and the bridge module 23 has a first memory controller 231 and a second memory controller 232, such as DRAM controllers, a core unit 233, and a graphic unit 234. Noted, the first memory controller 231 and the second memory controller 232 are independent respectively in the bridge module 23, and are used by the core unit 233 and the graphic unit 234 respectively.

The first memory controller 231 is connected to the first memory socket 21 through a first bus 235 for transmitting data, memory address and control signal of the first memory 24 installed in the first memory socket 21. In addition, the first bus 235 includes a data bus, an address bus and a control signal bus.

The second memory controller 232 is connected to the second memory socket 22 through a second bus 236 for transmitting data, memory address and control signal of the second memory 25 installed in the second memory socket 22. In addition, the second bus 236 includes a data bus, an address bus and a control signal bus.

In addition, the first bus 235 and the second bus 236 are independent of each other and can work simultaneously and independently.

The core unit 233 accesses the data of the first memory 24 through the first memory controller 231 and serves as the main memory of the personal computer system. The first memory controller 231 is electrically connected to a corresponding data transmission path in the first memory socket 21 through the data bus, electrically connected to a corresponding address transmission path in the first memory socket 21 through the address bus, and electrically connected to a corresponding control signal transmission path in the first memory socket 21 through the control signal bus.

The graphic unit 234 performs a graphic operation to generate a video signal for driving a display 12. Herein, the graphic unit 234 accesses the data of the second memory 25 through the second memory controller 232 and serves as a graphic memory of the personal computer system. The second memory controller 232 is electrically connected to a corresponding data transmission path in the second memory socket 22 through the data bus, electrically connected to a corresponding address transmission path in the second memory socket 22 through the address bus, and electrically connected to a corresponding control signal transmission path in the second memory socket 22 through the control signal bus.

As mentioned above, the graphic unit 234 can be connected to the second memory socket 22 and the second memory 25 directly through the second memory controller 232 in order to access the second memory 25, and the core unit 233 can be connected to the first memory socket 21 and the first memory 24 directly through the first memory controller 231 in order to serve as the main memory. Thus, the main memory does not have to be shared with the graphic unit 234, which is advantageous to the enhancement of the overall efficiency. The graphic unit 234 has an independent memory for use, which is advantageous to the enhancement of the frame quality. In addition, the user can adjust the memory capacity of the second memory 25 installed in the second memory socket 22 according to practical requirement so as to enhance the extensibility of the motherboard 2.

In addition, the present invention also provides a bridge module, such as the bridge module 23 mentioned hereinabove, and detailed descriptions thereof will be omitted for concise purpose.

In summary, the motherboard and the bridge module according to the present invention enable the user to replace the second memory installed in the second memory socket according to practical requirement, such that the personal computer system has excellent extensibility. In addition, the core unit and the graphic unit in the motherboard and the bridge module according to the present invention respectively access the first memory and the second memory as a main memory and a graphic memory through the first memory controller and the second memory controller, so the overall efficiency can be enhanced.

While the present invention has been described by way of example and in terms of a preferred embodiment, it is to be understood that the present invention is not limited thereto. To the contrary, it is intended to cover various modifications. Therefore, the scope of the appended claims should be accorded the broadest interpretation so as to encompass all such modifications.

What is claimed is:

1. A motherboard, comprising:
a first memory socket for coupling with a first memory;
a second memory socket for coupling with a second memory; and
a bridge module, comprising:
a first memory controller, connected to the first memory socket;
a second memory controller, connected to the second memory socket;
a core unit, accessing the first memory through the first memory controller; and
a graphic unit, accessing the second memory through the second memory controller.

2. The motherboard according to claim 1, wherein the first memory controller is connected to the first memory socket through a first bus.

3. The motherboard according to claim 2, wherein the second memory controller is connected to the second memory socket through a second bus.

4. The motherboard according to claim 3, wherein the first bus and the second bus are independent of each other and can work simultaneously.

5. The motherboard according to claim 1, wherein the bridge module is a north bridge module.

6. The motherboard according to claim 5, wherein the bridge module further comprises a south bridge module.

7. The motherboard according to claim 1, wherein the first memory socket and the second memory socket are a DIMM socket.

8. A bridge module working in conjunction with a first memory socket and a second memory socket, the bridge module comprising:
a first memory controller, connected to the first memory socket;
a second memory controller, connected to the second memory socket;
a core unit, connected to the first memory controller; and
a graphic unit, connected to the second memory controller.

9. The bridge module according to claim 8, wherein the first memory socket and the second memory socket are respectively coupled with a first memory and a second memory.

10. The bridge module according to claim 8, wherein the first memory controller is connected to the first memory socket through a first bus.

11. The bridge module according to claim 10, wherein the second memory controller is connected to the second memory socket through a second bus.

12. The bridge module according to claim 11, wherein the first bus and the second bus are independent of each other and can work simultaneously.

13. The bridge module according to claim 8, wherein the first memory socket and the second memory socket are a DIMM socket.

14. The bridge module according to claim 8, wherein the bridge module is a north bridge module.

15. The bridge module according to claim 8, further comprising a south bridge module.

16. The bridge module according to claim 8, wherein the bridge module, the first memory socket and the second memory socket are disposed on a motherboard.
